(19) United States
(12) Patent Application Publication
(10) Pub. No.: US 2009/0288271 A1
(43) Pub. Date: Nov. 26, 2009

(54) OVER CENTER SPRUNG HOOD HINGE FOR USE WITH ACTIVE PEDESTRIAN PROTECTION SYSTEM

(76) Inventors: Ryan F. Kmieciak, Redford, MI (US); Christoph Meese, Koln (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/124,604

(22) Filed: May 21, 2008

(51) Int. Cl. E05F 1/08

(52) U.S. Cl. 16/308; 16/277

(57) ABSTRACT

A hinge mechanism for deploying a vehicle pedestrian protection system is provided, including a first hinge element, a second hinge element, and a biasing mechanism. The hinge mechanism also includes a closed position and an open position, where at least a portion of the first hinge element and at least a portion of the second hinge element separate from one another when the hinge mechanism is urged from the closed position to the open position. The biasing mechanism exerts a biasing force. A first biasing position is defined where the biasing force is exerted at the first and second hinge elements for retaining the hinge mechanism in the closed position. A second biasing position is defined where the hinge mechanism is in the open position.

### TECHNICAL FIELD

The present disclosure relates to a hinge mechanism, and in particular to a hinge mechanism related to a vehicle.

### BACKGROUND

In recent years, some vehicles have included pedestrian protection systems that reduce the likelihood of injuries to pedestrians in the unfortunate event the vehicle hits a pedestrian in an accident. The pedestrian protection system is designed such that a hood of the vehicle absorbs an impact force that is generated by the pedestrian hitting the hood during the accident.

In one approach, a pedestrian protection system includes a pocket of empty space between a vehicle hood selectively enclosing an engine compartment and the engine components contained within the engine compartment. The pocket of space may be located adjacent to the cowl and the windshield of the vehicle, and generally opposite to a hood latch used to selectively engage the hood with the rest of the engine compartment. The pocket of space is intended to act as a cushion between the engine compartment components and the pedestrian, hopefully absorbing at least a portion of an impact force.

Including such a pocket of space at all times has become more and more difficult because of other constraints, not the least of which include vehicle weight, vehicle size, and vehicle aerodynamics or styling.

Accordingly, in accordance with another approach, the pedestrian protection system includes a deployable hood that is raised during an accident for creating the pocket of space. More specifically, in the event a pedestrian is impacted by the vehicle, the pedestrian protection system raises the hood upwardly and away from the vehicle's fenders.

There are several types of hinge mechanisms for a pedestrian protection system that may facilitate deployment of the hood in the event a pedestrian and a vehicle come into contact. For example, the hinge mechanism may include a shear pin. Under normal operation, the shear pin maintains the hinge mechanism in a closed non-air space orientation. However, under appropriate conditions such as when a pedestrian and the vehicle collide, the shear pin may be broken. When the shear pin breaks or otherwise shears the hinge mechanism moves from its closed non-air space orientation to an open orientation, raising the hood so that a pocket of space is created as discussed above. Until the pin is replaced, the hood orientation may inadvertently compromise sight lines associated with vehicle operation.

The pedestrian protection system may also include a specialized latching system. The latching system is used to deploy the hinge mechanism. One drawback is that once the hinge mechanism is deployed, such a specialized latching system will not allow for a user to completely return the hinge to its original pre-deployed closed non-air space orientation. For example, the hood may not be flush with the fenders. Once again, the process may be cumbersome and expensive to perform often requiring the services of a technician. Moreover, vehicle operation may be inadvertently impaired as noted above.

Accordingly, there is a need for a hinge mechanism that minimizes the number of components, while still allowing the hinge mechanism to shut completely such that the hood is flush with the fenders of the automobile.

### BRIEF DESCRIPTION OF THE DRAWINGS

FIG. 1A is a partially sectioned view of a vehicle including a pedestrian protection system, where a hood of the vehicle is in a pre-deployed position;

FIG. 1B is a partially sectioned view of the vehicle in FIG. 1A, where a hinge mechanism of the protection system positions the hood in a deployed position;

FIG. 2A is an enlarged, partially sectioned view of the hinge mechanism of the protection system in a closed position and including a torsion spring;

FIG. 2B is an enlarged, partially sectioned view of the hinge mechanism of FIG. 2A in an open position;

FIG. 2C is an enlarged view of the hinge mechanism and the torsion spring as seen in FIG. 2B;

FIG. 3 is an is an alternative illustration of the hinge mechanism in the closed position;

FIG. 4A is an enlarged view of the hinge assembly in FIG. 2A, where the spring is in a first spring position;

FIG. 4B is an enlarged view of the hinge assembly in FIG. 2B, where the spring is in a second spring position;

FIG. 5 is a partially exploded view of the hinge assembly including the spring, a first hinge strap and a second hinge strap; and

FIG. 6 is a process flow diagram of a method of deploying the hood of the vehicle by the hinge mechanism.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

Moreover, a number of constants may be introduced in the discussion that follows. In some cases illustrative values of the constants are provided. In other cases, no specific values are given. The values of the constants will depend on characteristics of the associated hardware and the interrelationship of such characteristics with one another as well as environmental conditions and the operational conditions associated with the disclosed system.

According to various exemplary illustrations described herein, a hinge mechanism for selectively deploying a vehicle pedestrian protection system is provided. The protection system may include a first hinge element, a second hinge element and a biasing mechanism. The hinge mechanism may also include a closed position and an open position, where at least a portion of the first hinge element and at least a portion of the second hinge element are distanced from one another when the hinge mechanism is urged from the closed position to the open position. The biasing mechanism exerts a biasing force, and may include a first portion and a second portion, where the first portion is acting on the first hinge element and the second portion is acting on the second hinge element. A first biasing position may be defined where the biasing force is exerted at the first and second elements for retaining the hinge mechanism in the closed position. A second biasing position may be defined where the biasing mechanism is rotated about at least one of the first portion and the second portion and the hinge mechanism is in the open position. In one example, the biasing mechanism may be a torsion spring.

A common pivot point may also be included, where the first hinge element and the second hinge element rotate about the common pivot point when the hinge mechanism is urged into the open position. The biasing force may be exerted at the first hinge element and the second hinge element in the second biasing position as well, for retaining the hinge mechanism in the open position. A line of action of the biasing force may be rotated about at least the second portion of the biasing mechanism and through the pivot point as the hinge mechanism is urged from the closed position into the open position.

A method of deploying a hood of a vehicle by a hinge mechanism is also disclosed. The method may include connecting a first end portion of the biasing mechanism with the first hinge element of the hinge mechanism and a second end portion of the biasing mechanism with the second hinge element of the hinge mechanism. The method may further include exerting a biasing torque from the biasing mechanism at the first hinge element and the second hinge element of the hinge mechanism, where the biasing mechanism is in a first biasing position. The hinge mechanism may be secured in a closed position when the biasing mechanism is in the first biasing position. An external force may then be exerted on the hinge mechanism to urge the biasing mechanism from the first biasing position into a second biasing position. The hinge mechanism is urged into an open position as the biasing mechanism is rotated into the second biasing position.

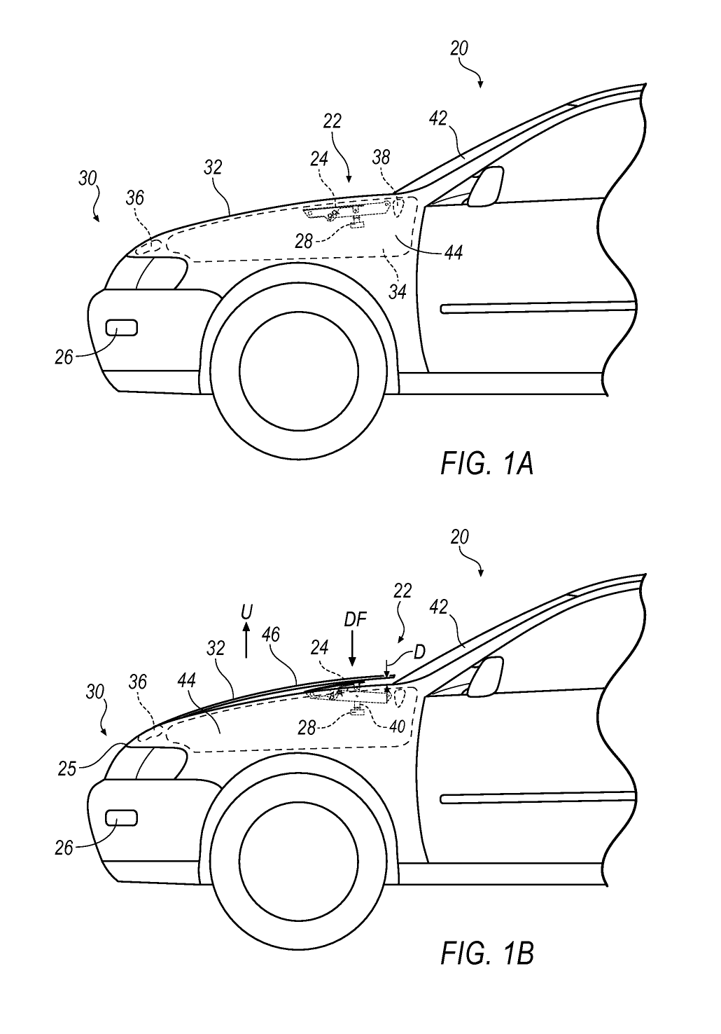

Turning now to the drawings and in particular to FIG. 1A, an exemplary vehicle 20 including a pedestrian protection system 22 is disclosed. The protection system 22 is located underneath a hood 32 and inside of an engine compartment 34 of the vehicle 20. The protection system 22 may include a hinge mechanism 24, a crash sensor 26 and an actuator 28. FIG. 1A illustrates the crash sensor 26 mounted at a front end 30 of the vehicle 20 to detect when the front end 30 of the vehicle 20 makes contact with a foreign object such as a human body (not shown) in an automobile-pedestrian accident. In one example, the crash sensor 26 may be able to discriminate between an inanimate object and a living being, such as a human body. When an inanimate object is contacted by the front end 30, the protection system 22 may not deploy into the position as seen in FIG. 1B, which discussed in greater detail below. Thus, if the vehicle 20 makes contact with an object such as a telephone pole instead of a human body, the protection system 22 may not deploy.

In the illustration as shown, the hood 32 is in a pre-deployed position. That is, the hood 32 of the vehicle 20 is shut closed. In the event the front end 30 contacts an obstruction, the hood 32 will be deployed by the protection system 22, as seen in FIG. 1B. The hood 32 is opened, and urged in an upwards direction U by way of the hinge mechanism 24 that is in communication with the hood 32. The hinge mechanism 24 is in communication with the actuator 28. The actuator 28 receives a communication from the crash sensor 26 (e.g. an electronic signal), and when an object is contacted by the front end 30, the crash sensor 26 sends a communication such as an electronic signal to the actuator 28. The communication drives a shaft 40 of the actuator 28 in the direction U, thereby deploying the hinge mechanism 24, as discussed in greater detail below.

As seen in FIG. 1B, the hood 32 is deployed in the direction U such that the hood 32 is not flush with a fender 44 of the vehicle 20. More specifically, as seen in FIG. 1A, the hood 32 is in a pre-deployed position and is flush with the fender 44. FIG. 1B illustrates the hood 32 in a deployed position and raised at a predetermined distance D from the fender 44. In one illustration, the distance D between the hood 32 and the fender 44 is between about two inches (2.0 in) to about four inches (4.0 in) (50.0 millimeters to about 100.0 millimeters). The distance D depends on the type and model of the vehicle 20.

The hinge mechanism 24 may be located in a position that is generally opposite to a hood latch 36 inside of the engine compartment 34 and adjacent to a cowl 38. Thus, when the hood 32 is deployed, the predetermined distance D may be located adjacent to a windshield 42 and located generally opposite the hood latch 36. That is, the hood 32 may be raised by the hinge mechanism 32 in a direction that generally opposes a seam 25 of the hood 32 that is located along the front end 30. The seam 25 is interrupted when the hood 32 is traditionally opened for servicing meaning that the hood is raised away from the fenders 44. For example, when a user desires to check the oil, or perform maintenance to the underhood engine components such as the engine (not shown), the user detaches the hood latch 36 from the hood 32, and raises the hood 32 upwardly.

After the hood 32 is deployed by the protection system 22, a user may selectively apply a downward force DF along an outer surface 46 of the hood 32. The downward force DF urges the hood 32 from the deployed position as seen in FIG. 1B to a post-deployment position, similar to the configuration as seen in FIG. 1A. More specifically, the post-deployment position of the hood 32 may be locationally very close to or the same as the pre-deployment position of the hood 32.

Thus, in the event the vehicle 20 is involved in an automobile-pedestrian accident, the user can reposition the hood 32 such that the hood 32 is returned to be generally flush with an appropriate vehicle component such as the fender 44. However, it should be noted that while the hood 32 may be repositioned back into the pre-deployment position, the protection system 22 may be unable to redeploy and raise the hood 32 yet again until the vehicle 20 is serviced, as discussed in greater detail below.

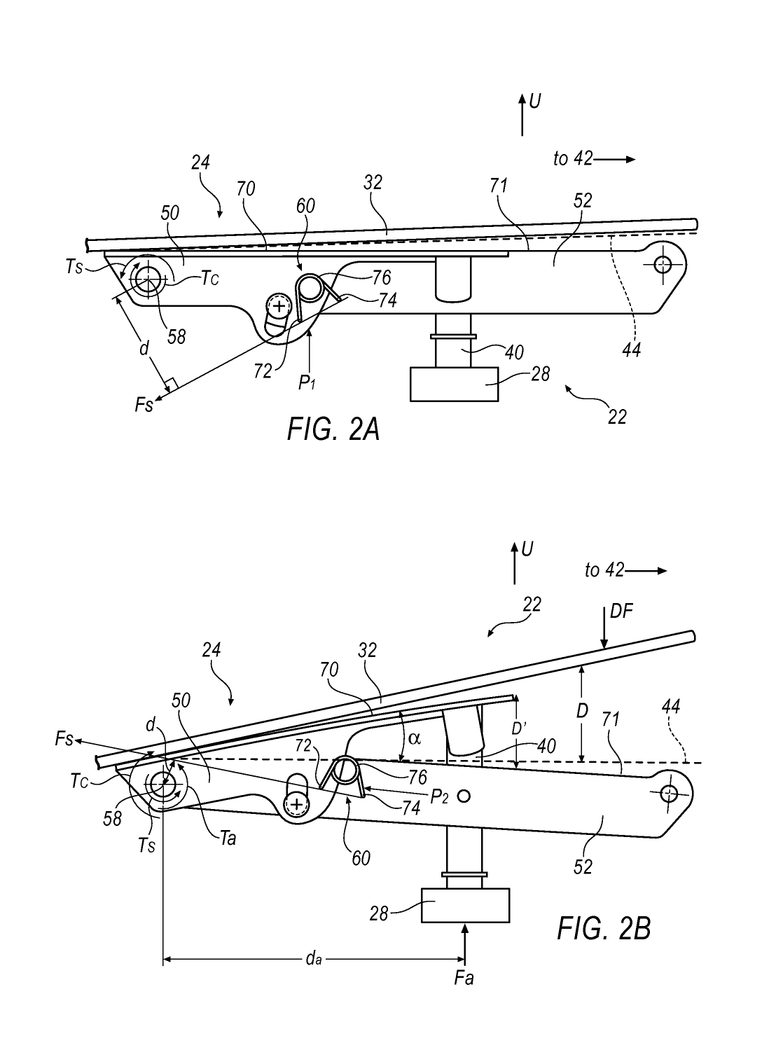

FIG. 2A illustrates the protection system 22 and the hood 32 in a closed position. In the illustrated example the hinge mechanism 24 includes a first element in the form of a hinge strap 50, a second element in the form of a second hinge strap 52, a common pivot point 58, and a biasing mechanism illustrated by way of example as a torsion spring 60. Various biasing mechanisms may be used. Nevertheless, in the illustration as shown, a biasing mechanism in the form of spring 60 includes a first end 72, a second end 74 and a coil portion 76. The first end 72 of the spring 60 is rotatably connected with and acts on the first hinge strap 50, and the second end 74 is rotatably connected with and acts on the second hinge strap 52. The first hinge strap 50 and the second hinge strap 52 are secured in the closed position by the spring 60, as discussed in greater detail below. The exemplary biasing mechanism is a specialized torsion spring in the form of a wound spring. Moreover, although the illustration only includes the first and second hinge straps 50 and 51, more than two elements may be used including more than two hinge straps.

In the illustration as shown, the hinge mechanism 24 is closed. That is, the first hinge strap 50 may be generally aligned with the second hinge strap 52. FIG. 2A also illustrates an upper surface 70 of the first hinge strap 50 that may be generally parallel with an upper surface 71 of the second hinge strap 52. However, as discussed below, the hinge mechanism 24 may be secured in the closed position even when the first hinge strap 50 and the second hinge strap 52 are not generally aligned with one another.

The biasing mechanism in the form of spring 60 limits rotation of the hinge mechanism 24 by a spring force Fs. More specifically, the spring 60 aids in maintaining the hinge mechanism 24 in the position as seen in FIG. 1A where the hood 32 is generally flush with the fender 44. The spring 60 limits rotation such that the hinge mechanism 24 will not rotate and deploy into the position as seen in FIG. 1B where the hood 32 is raised at the predetermined distance D from the fender 44 until a sufficiently great outside force is exerted upon the protection system 22, as discussed below. The common pivot point 58 includes a closing torque Tc.

The hinge mechanism 24 may be maintained in the closed position because the spring force Fs, in the exemplary approach, exerts an application torque Ts on the hinge straps 50 and 52. The application torque Ts is the spring force Fs multiplied by a spring distance d. The spring distance d is measured from the common pivot point 58 to the second end 74, as seen in FIG. 2A. Because the application torque Ts is greater than the closing torque Tc, the hinge mechanism 24 is closed. FIG. 2A also illustrates the spring 60 when in a first spring position P1 where the application torque Ts is exerted at the first and second hinge straps 50 and 52 to retain the hinge mechanism 24 in the closed position. It is only when the application torque Ts is overcome that the hinge mechanism 24 is urged open.

The hinge mechanism 24 is urged into the open position as seen in FIG. 2B, where the actuator 28 drives the shaft 40 in the direction U. An upwards force Fa is exerted from the shaft 40 on at least the first hinge strap 50, and urges the hood 32 into the deployed position. More specifically, the upwards force Fa exerts an actuator torque Ta. The actuator torque Ta is the actuator force Fa multiplied by a distance da that is measured between the common pivot point 58 and the actuator force Fa. In the illustration as shown, the upwards force Fa may be generally perpendicular to at least one of the upper surface 70 of the first hinge strap 50 and the upper surface 71 of the second hinge strap 52 that define the hinge mechanism 24 in the closed position.

Because the actuator torque Ta is greater than the application torque Ts, is hinge mechanism 24 is urged open. That is, when the actuator 28 drives the shaft 40 and exerts the force Fa, this creates the actuator torque Ta that overcomes the application torque Ts, and as a result the hinge mechanism 24 is opened. The surface 70 of the first hinge strap 50 makes contact with and urges the hood 32 upwardly in the direction U when the hinge mechanism 24 is opened. The hood 32 may be raised the distance D from the fender 44, and the first hinge strap 50 may be raised at a predetermined distance D′ from the second hinge strap. The distance D′ may be measured from the upper surface 70 of the first hinge strap 50 to the upper surface 71 of the second hinge strap 52 and taken using a free end of the strap 50.

When the first hinge strap 50 of the hinge mechanism 24 is raised at the predetermined distance D′, the hinge mechanism 24 is in the open position. That is, the upper surface 70 of the first hinge strap 50 may no longer be generally parallel with the upper surface 71 of the second hinge strap 52, and the first hinge strap 50 may be angled from the second hinge strap 52. More specifically, the predetermined distance D′ may be formed by an angle α that is located between the upper surface 70 of the first hinge strap 50 to the upper surface 71 of the second hinge strap 52.

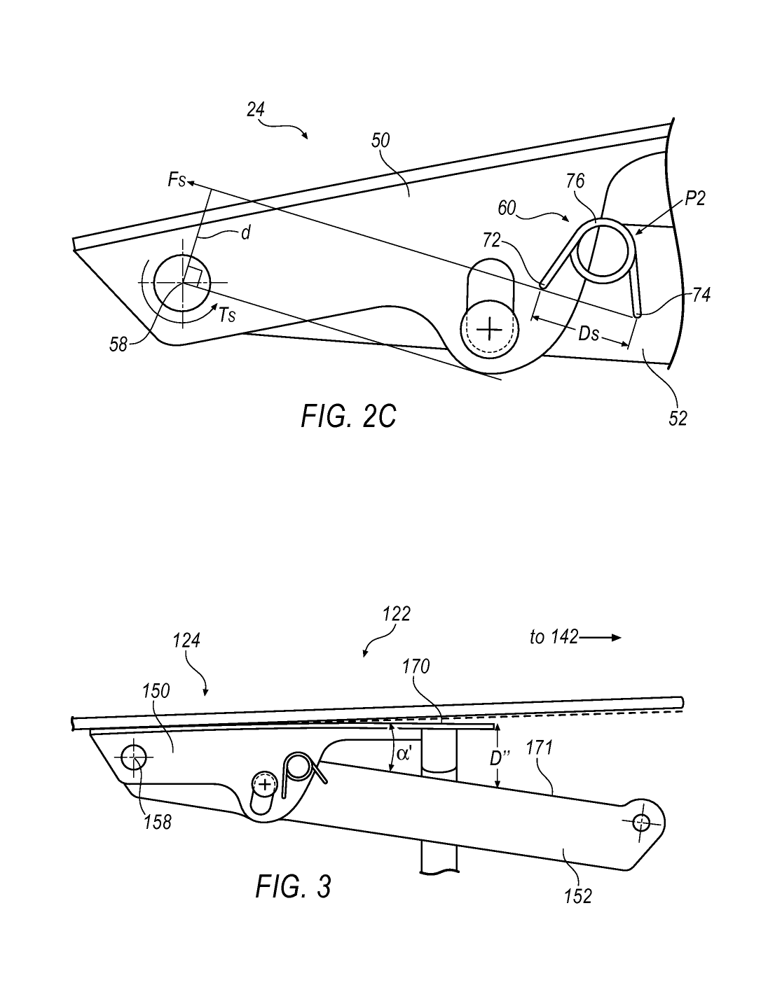

At least a portion of the first hinge strap 50 and the second hinge strap 52 rotate about the common pivot point 58, and separate from one another when the hinge mechanism 24 is urged from the closed position to the open position. It should be noted that while FIG. 2A illustrates the first hinge strap 50 and the second hinge strap 52 generally aligned with one another, a vertical distance may also be included between the upper surfaces 170 and 171 of the first and second hinge straps 150 and 152, as seen in the alternative illustration of FIG. 3.

FIG. 3 is an alternative illustration of the protection system 122 including the hinge mechanism 124 in the closed position. The vertical distance, illustrated as the predetermined distance D″ is located between the first hinge strap 150 and the second hinge strap 152. In the illustration as shown, the predetermined distance D″ will increase between the first and second hinge straps 150 and 152 as the hinge mechanism 124 is urged into the open position. Moreover, the first hinge strap 150 may be angled from the second hinge strap 152 when the hinge mechanism 24 is in the closed position. In the illustration as shown, the angle α′ is located between the first hinge strap 150 and the second hinge strap 152. When the hinge mechanism 124 is urged in the open position, the angle α′, as well as the predetermined distance D″, will increase between the first hinge strap 150 and the second hinge strap 152. More specifically, the predetermined distance D″ is measured from the upper surface 170 of the first hinge strap 150 to the upper surface 171 of the second hinge strap 152 and taken using a free end of the strap 150.

Turing back to FIG. 2B, the spring 60 secures the first hinge strap 50 at the first end 72 and the second hinge strap 52 at the second end 74. The hinge mechanism 24 is secured at the predetermined distance D′ when the spring 60 is in a second spring position P2. The spring 60 is urged into the second spring position P2 when the spring 60 rotates about at least one of the first end 72 and the second end 74. That is, as the spring 60 is rotated, the orientation of the spring 60 changes from the first position P1 to the second position P2, and urges the hinge mechanism 24 into the open position. When the hinge mechanism 24 is in the open position, the spring 60 may limit rotation of the first hinge strap 50 and the second hinge strap 52, and secures the hinge mechanism 24 at the predetermined distance D′, as discussed below.

The application torque Ts is exerted from the spring 60 retains the hinge mechanism 24 in the open position when the actuator force Fa is no longer exerted on the hinge mechanism 24. FIG. 2C is an enlarged view of the spring 60 connected to the first hinge strap 50 and the second hinge strap 52 of FIG. 2B. As best seen in FIG. 2C, the application torque Ts is calculated by the spring force Fs multiplied by the spring distance d. As the spring 60 rotates between the first spring position P1 and the second spring position P2, the spring 60 compresses, and the size of the coil portion 74 may decrease in size. However, when the spring 60 reaches the second spring position P2, the coil portion 74 returns to about the same size as the coil portion 74 was in the first spring position P1. That is, a distance Ds measured between the first end portion 72 in relation to the second end portion 74 decreases as the spring 60 rotates between the first spring position P1 (as seen in FIG. 2A) and the second spring position P2 (as seen in FIGS. 2B and 2C), but the distance Ds is about the same when measured at the first spring position P1 and at the second spring position P2.

The overall value of the spring force Fs increases as the spring 60 is rotated from the first spring position P1 to the second spring position P2, however, the application torque Ts will generally decrease. More specifically, the application torque Ts witnessed at the common pivot point 58 decreases as the spring distance d is decreased. The spring distance d is decreased as the spring 60 travels from the first spring position P1 (seen in FIG. 2A) to the second spring position P2 (seen in FIG. 2B), thereby reducing the application torque Ts as well.

The spring force Fs is illustrated in FIGS. 2A, 2B and 2C as a line of action that rotates about the second end 74 as the hinge mechanism 24 is urged open. The line of action of the spring force Fs may pass through the common pivot point 58 as the hinge mechanism 24 moves from the closed position to the open position. As seen in FIG. 2A, when the spring 60 is in the first spring position P1, the spring 60 exerts the application torque Ts on the hinge straps 50 and 52, and retains the hinge mechanism 24 in the closed position.

As the hinge mechanism 24 is urged into the open position as seen in FIGS. 2B and 2C, the spring 60 is rotated about at least one of the first end 72 and the second end 74. As the actuator force Fa is exerted on the first hinge strap 50, rotation between the first hinge strap 50 and the second hinge strap 52 is limited by movement of a pin 82, (connected to the second hinge strap 52) within a slotted hole 80 (located in the first hinge strap 50) and is discussed in greater detail below. That is, the first hinge strap 50 may only be raised at the distance D′ from the second hinge strap 52. The first hinge strap 50 and the second hinge strap 52 each rotate about the common pivot point 58 when the hinge mechanism 24 is urged into the open position.

When the hinge mechanism 24 is in the closed position, the spring 60 is in the first spring position P1. The application torque Ts is overcome by the actuator torque Ta. The line of action of the spring force Fs rotates from the position as seen in FIG. 2A to the position as seen in FIGS. 2B and 2C, and passes though the common pivot point 58 as the spring 60 rotates from the first position P1 to the second position P2. In the illustration as shown, the spring force Fs is exerted when the spring 60 is in the second spring position P2 and retains the hinge mechanism 24 in the open position after the actuator force Fa has been removed.

As discussed above, after the hood 32 is deployed, a user may selectively apply the downward force DF along the outer surface 46 of the hood 32 to urge the hood 32 from the deployed position as seen in FIG. 1B to a post-deployment configuration as seen in FIG. 1A. That is, the hinge mechanism 24 is urged from the open position, as seen in FIG. 2A, into the closed position, as seen in FIG. 2A, by the downward force DF that is exerted at least on the first hinge strap 50. As seen in FIG. 2A, the spring 60 is urged back into in the first spring position P1 when the downward force DF is exerted on the hood 32. The as the spring 60 changes orientation, the line of action of the spring force Fs is rotated though the common pivot point 58 as well. As seen in FIG. 2B, the downward force DF may be generally opposite to the actuator force Fa.

It should be noted that even though the hood 32 is closed shut when the downwards force DF is exerted on the hood 32, and the hinge mechanism 24 is also closed, the protection system 22 may be unable to deploy the hood 32 again until the vehicle 20 is serviced. During servicing, at least the actuator 28 could be replaced or otherwise reset. However, one advantage of the protection system 22 is that hinge mechanism 24, as well as the spring 60, will need no servicing or replacement. Instead, the hinge mechanism 24 is capable of deploying several times before the hinge mechanism 24 and the spring 60 will need to be replaced.

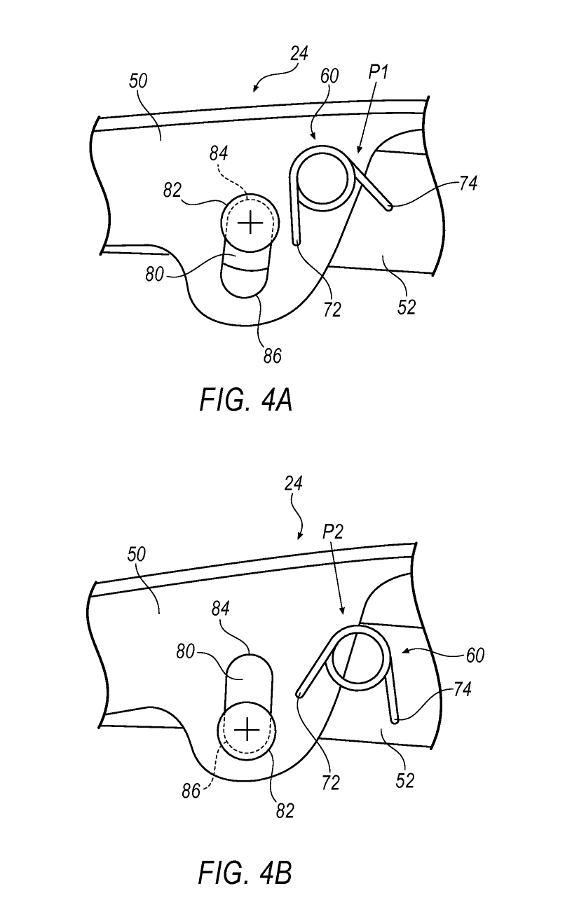

As seen in FIG. 2B, the first hinge strap 50 is limited in movement and can only be raised at the distance D′ from the second hinge strap 52. Moreover, as best seen in FIGS. 4A and 4B, movement of the first hinge strap 50 relative to the second hinge strap 52 may also be limited because the first hinge strap 50 includes the slotted hole 80 and the second hinge strap 52 may be connected to the pin 82. FIG. 4A illustrates the hinge mechanism 24 in the closed position and the spring 60 in the first position P1, and FIG. 4B illustrates the hinge mechanism 24 in the open position and the spring 60 in the second spring position P2. The slotted hole 80 includes a first stop 84 and a second stop 86. FIG. 4A illustrates the pin 82 in engagement with the slotted hole 80, with the pin 82 resting at the first stop 84, while FIG. 4B illustrates the pin 82 resting at the second stop 86. Movement of the pin 82 may be restricted to the slotted hole 80.

Having the pin 82 travel inside the slotted hole 80 may provide additional structural integrity of the hinge mechanism 24. This is because the pin 82 may be limited in travel by the first stop 84 and a second stop 86 of the slotted hole 80. Moreover, as seen in FIG. 4B, the slotted hole 80 acts as an additional catching mechanism to limit the travel of the first hinge strap 50 relative to the second hinge strap 52 when the hinge mechanism 24 is urged into the open position. That is, the first stop 84 restrains the pin 82 when the hinge mechanism 24 is urged into the open position. Indeed, the pin 82 may be retained by the slotted hole 80 along the second stop 86. That is, the pin 82 rests along the second stop 86. The second stop 86 will not allow for additional travel of the pin 82 inside the slotted hole 80.

In the illustration as shown in FIGS. 4A and 4B, the slotted hole 80 is generally linear in shape. However, the slotted hole 80 may not be a linear slot and include other shapes as well. For example, the slotted hole 80 may be curved, or include an overall non-linear shape. Any shape of the slotted hole 80 may be used so long as the pin 82 may be able to in travel between two stops for retaining the predetermined distance D′ as the hinge mechanism 24 is urged into the open position. Indeed, the slotted hole 80 may include a variety of shapes and sizes.

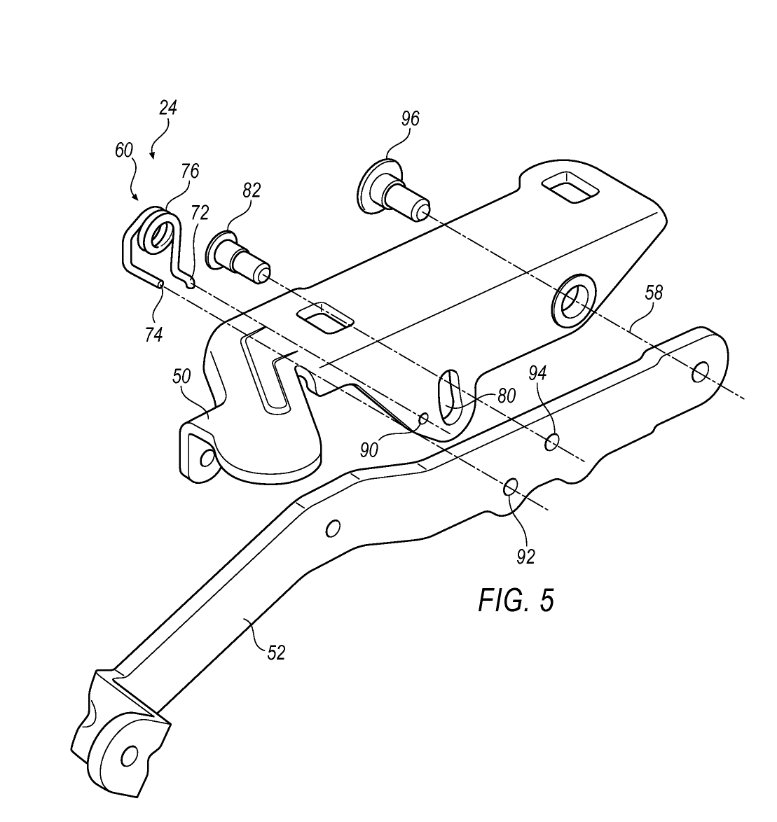

FIG. 5 is a partially exploded view of the hinge mechanism 24. The spring 60 is rotatably connected to the first hinge strap 50 when the first end 72 is received by a first aperture 90 located in the first hinge strap 50. The second end 74 is received by a second aperture 92 located in the second hinge strap 52. The pin 82 may be received by the slotted hole 80 located in the first hinge strap 50, and may be connected to the second hinge strap 52 at a pin aperture 94. A pivot pin 96 connects the first and second hinge straps 50 and 52 together at the common pivot point 58.

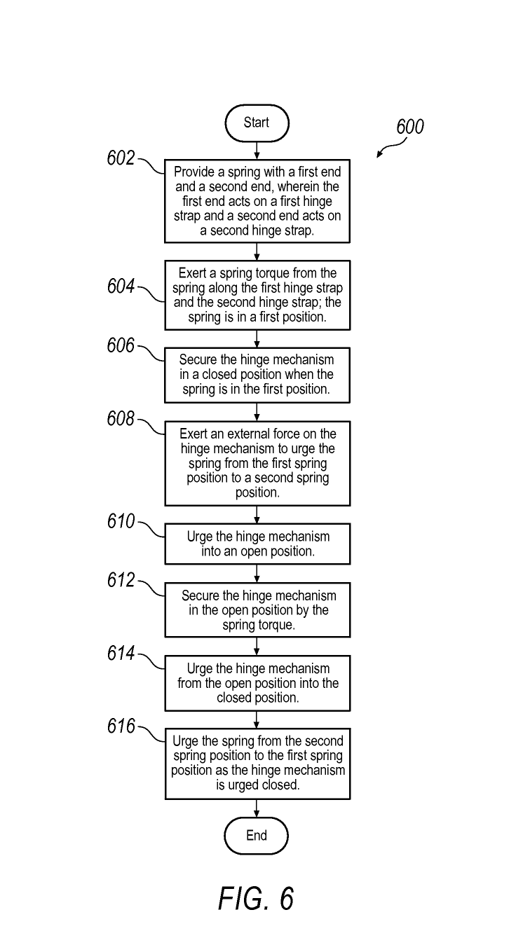

Turning now to FIG. 6, a process 600 of deploying the hood 32 of the vehicle 20 by the hinge mechanism 24 is illustrated. Process 600 may begin at step 602, where a biasing mechanism, illustrated as the spring 60 is provided. The spring 60 includes the first end 72 and the second end 74. For example, as discussed above, the first end 72 acts on the first hinge strap 50, and the second end 74 acts on the second hinge strap 52. In the illustration as best seen in FIG. 5, the first end 72 is received by the first aperture 90 located in the first hinge strap 50 and the second end 74 is received by the second aperture 92 of the second hinge strap. Process 600 may then proceed to step 604.

In step 604, the application torque Ts from the spring 60 is exerted along the first hinge strap 50 and the second hinge strap 52 of the hinge mechanism 24. The spring 60 is in the first spring position P1 when the application torque Ts is exerted. As discussed above, the spring force Fs exerts the application torque Ts on the hinge straps 50 and 52, where the application torque Ts is the spring force Fs multiplied by the spring distance d. The spring distance d is measured from the common pivot point 58 to the spring force Fs. Process 600 may then proceed to step 606.

In step 606, the hinge mechanism 24 is secured in the closed position when the spring is in the first spring position P1. More specifically, the spring 60 limits rotation of the hinge mechanism 24 by the spring force Fs when the hinge mechanism 24 is closed. In the closed position, the first hinge strap 50 and the second hinge strap 52 may be generally aligned. For example, as discussed above, the upper surface 70 of the first hinge strap 50 may be generally parallel with the upper surface 71 of the second hinge strap 52.

However, in the alternative illustration as seen in FIG. 3 a vertical distance may be included and is the predetermined distance D″. The predetermined distance D″ may be included between the first and second hinge straps 150 and 152 when the hinge mechanism 124 is closed. In the illustration as shown in FIG. 3, the predetermined distance D″ is measured from the upper surface 170 of the first hinge strap 150 to the upper surface 171 of the second hinge strap 152 and taken using a free end of the strap 150. Process 600 may then proceed to step 608.

In step 608, the actuator force Ta is exerted on the hinge mechanism 24, urging the spring 60 from the first spring position P1 into the second spring position P2. For example, as discussed above, when the actuator 28 drives the shaft 40 in the direction U, the upwards force Fa is exerted from the shaft 40 on at least the first hinge strap 50. More specifically, the upwards force Fa exerts the actuator torque Ta, where the actuator torque Ta is the actuator force Fa multiplied by the distance da. In one illustration, the upwards force Fa may be generally perpendicular to at least one of the upper surface 70 of the first hinge strap 50 and the upper surface 71 of the second hinge strap 52 when the hinge mechanism 24 is in the closed position. Process 600 may then proceed to step 610.

In step 610, the application torque Ts is overcome, urging the hinge mechanism 24 into the open position when the spring 60 is in the second spring position P2. That is, because the actuator torque Ta is greater than the application torque Ts, the hinge mechanism 24 is urged open. When the actuator 28 drives the shaft 40 and exerts the force Fa, this creates the actuator torque Ta that overcomes the application torque Ts. The spring 60 is urged from the first spring position P1 into the second spring position P2 when the application torque Ts is overcome by the actuator torque Ta. At least a portion of the first hinge strap 50 is separated from at least a position of the second hinge strap 52 as the hinge mechanism 24 is urged open. Process 600 may then proceed to step 612.

In step 612, the hinge mechanism 24 is secured in place in the open position by the application torque Ts. For example, as discussed above, the application torque Ts aids in retaining the hinge mechanism 24 in the open position when the actuator force Fa is no longer exerted on the hinge mechanism 24. The application torque Ts is calculated by the spring force Fs multiplied by the spring distance d. Process 600 may then proceed to step 614.

In step 614, the hinge mechanism 24 is urged from the open position into the closed position. For example, as discussed above, when the downwards force DF is exerted on the hood 32, the hinge mechanism 24 may be urged closed. The downwards force DF is generally exerted by a user on the outer surface 46 of the hood 32. A user may desire to shut the hood 32 of the vehicle 20 after deployment of the protection system 22. Process 600 may then proceed to step 616.

In step 616, the spring 60 is urged from the second spring position P2 to the first spring position P1 as the hinge mechanism 24 is closed. For example, as discussed above, the spring 60 is urged back into in the first spring position P1 when the downward force DF is exerted on the hood 32. Although the hood 32 is closed shut when the downwards force DF is exerted on the hood 32, and the hinge mechanism 24 is also closed, the protection system 22 may be unable to deploy the hood 32 again until the vehicle 20 is serviced. However, the spring 60 and the hinge mechanism 24 will need no servicing or replacement, and may be deployed several times before being replaced. Process 600 may then terminate.

The present disclosure has been particularly shown and described with reference to the foregoing illustrations, which are merely illustrative of the best modes for carrying out the disclosure. It should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements. Moreover, the foregoing illustrations are illustrative, and no single feature or element is essential to all possible combinations that may be claimed in this or a later application.

What is claimed is:

1. A hinge mechanism for deploying a vehicle pedestrian protection system, comprising:
a first hinge element and a second hinge element, the hinge elements positioned in relationship to one another;
a closed position and an open position, wherein at least a portion of the first hinge element and at least a portion of the second hinge element separate from one another when the hinge mechanism is urged from the closed position to the open position;
a biasing mechanism having a first portion and a second portion, the biasing mechanism exerting a biasing force between the first portion and the second portion, the first portion acting on the first hinge element and the second portion acting on the second hinge element;
a first biasing position where the biasing force is exerted along the first and second elements for retaining the hinge mechanism in the closed position; and
a second biasing position where the hinge mechanism is in the open position.

2. The hinge mechanism as recited in claim 1, further comprising a common pivot point, the first hinge element and the second hinge element rotating about the common pivot point when the hinge mechanism is urged into the open position.

3. The hinge mechanism as recited in claim 2, wherein the biasing mechanism is configured to be urged from the second biasing position to the first biasing position when a line of action of the biasing force is rotated though the common pivot point as the hinge mechanism is urged from the open position into the closed position.

4. The hinge mechanism as recited in claim 2, wherein the biasing force is exerted at the first hinge element and the second hinge element in the second biasing position for retaining the hinge mechanism in the open position.

5. The hinge mechanism as recited in claim 4, wherein a line of action of the biasing force is rotated about at least the second portion and though the common pivot point as the hinge mechanism is urged from the closed position into the open position.

6. The hinge mechanism as recited in claim 1, wherein an external force that is exerted on at least on the first hinge element and the second hinge element urges the hinge mechanism from the closed position to the open position.

7. The hinge mechanism as recited in claim 1, wherein the first portion is a first end portion of the biasing mechanism and the second portion is a second end portion of the biasing mechanism.

8. The hinge mechanism as recited in claim 1, further comprising a pin and a slotted hole where the pin is slideable within the slotted hole, the pin connected to the second hinge element and the slotted hole located at the first hinge element, the pin limiting travel between the first hinge element and the second hinge element by way of the slotted hole when the hinge mechanism is urged into the open position.

9. The hinge mechanism as recited in claim 8, wherein the slotted hole includes a first stop, the pin restrained by the first stop when the hinge mechanism is in the closed position.

10. The hinge mechanism as recited in claim 1, wherein the biasing mechanism is a torsion spring.

11. The hinge mechanism as recited in claim 1, wherein the hinge mechanism is deployed into the open position when a front end of a vehicle contacts a living being, and the hinge mechanism remains in the closed position when the front end of the vehicle contacts an inanimate object.

12. The hinge mechanism as recited in claim 1, wherein the biasing force generally increases as the spring mechanism is urged from the first biasing position into the second biasing position.

13. A hinge mechanism, comprising:
a first hinge element and a second hinge element, the hinge elements positioned in relationship to one another;
a closed position and an open position, wherein at least a portion of the first hinge element and at least a portion of the second hinge element separate from one another when the hinge mechanism is urged from the closed position to the open position;
a common pivot point, the first hinge element and the second hinge element rotating about the common pivot point when the hinge mechanism is urged into the open position;
a biasing mechanism that exerts a biasing force, including a first portion and a second portion, the first portion acting on the first hinge element and the second portion acting on the second hinge element;
a first biasing position where the biasing force is exerted at the first and second straps for retaining the hinge mechanism in the closed position; and
a second biasing position the hinge mechanism is in the open position;
wherein a line of action of the biasing force is rotated about at least the second portion and though the common pivot point as the hinge mechanism is urged from the closed position into the open position;
wherein the biasing force is exerted at the first hinge element and the second hinge element in the second biasing position for retaining the hinge mechanism in the open position.

14. The hinge mechanism as recited in claim 13, wherein the biasing mechanism is configured to be urged from the second biasing position to the first biasing position when the line of action of the biasing force is rotated though the common pivot point as the hinge mechanism is urged from the open position into the closed position.

15. The hinge mechanism as recited in claim 13, wherein an external force that is exerted on at least on the first hinge element and the second hinge element urges the hinge mechanism from the closed position to the open position.

16. The hinge mechanism as recited in claim 13, wherein the first portion is a first end portion of the biasing mechanism and the second portion is a second end portion of the biasing mechanism.

17. The hinge mechanism as recited in claim 13, further comprising a pin and a slotted hole where the pin is slideable within the slotted hole, the pin connected to the second hinge element and the slotted hole located at the first hinge element, the pin limiting travel between the first hinge element and the second hinge element by way of the slotted hole when the hinge mechanism is urged into the open position.

18. The hinge mechanism as recited in claim 17, wherein the slotted hole includes a first stop, the pin restrained by the first stop when the hinge mechanism is in the closed position.

19. A method of deploying a hood of a vehicle by a hinge mechanism, comprising the steps of:
providing a biasing mechanism with a first end portion and a second end portion, wherein the first end portion acts on a first hinge element of the hinge mechanism and the second end portion acts on a second hinge element of the hinge mechanism;
exerting a biasing torque from the biasing mechanism at the first hinge element and the second hinge element of the hinge mechanism, the biasing mechanism in a first biasing position;
securing the hinge mechanism in a closed position when the biasing mechanism is in the first biasing position;
exerting an external force on the hinge mechanism to urge the biasing mechanism from the first biasing position into a second biasing position; and
urging the hinge mechanism into an open position as the biasing mechanism is rotated into the second biasing position;
wherein at least a portion of the first hinge element and at least a portion of the second hinge element separate from one another when the hinge mechanism is urged from the closed position to the open position.

20. The method as recited in claim 19, further comprising the step of securing the hinge mechanism in the open position by the biasing torque.

21. The method as recited in claim 19, further comprising the step of urging the hinge mechanism from the open position into the closed position.

22. The method as recited in claim 21, further comprising the step of urging the biasing mechanism from the second biasing position to the first biasing position as the hinge mechanism is urged into the closed position.
